(19) United States
(12) Patent Application Publication
(10) Pub. No.: US 2011/0211035 A1
(43) Pub. Date: Sep. 1, 2011

(54) VOICE COMMUNICATION APPARATUS AND VOICE COMMUNICATION METHOD

(75) Inventors: Yasuji Ota, Kawasaki (JP); Masanao Suzuki, Kawasaki (JP); Kaori Endo, Kawasaki (JP); Takeshi Otani, Kawasaki (JP); Takaya Yamamoto, Kawasaki (JP)

(73) Assignee: FUJITSU LIMITED, Kawasaki-shi (JP)

(21) Appl. No.: 12/871,018

(22) Filed: Aug. 30, 2010

(30) Foreign Application Priority Data
Aug. 31, 2009 (JP) 2009-199855

(51) Int. Cl. H04N 7/14

(52) U.S. Cl. 348/14.01; 348/E07.077

(57) ABSTRACT

A communication apparatus includes an image capturing unit configured to capture a face image of a user; a contour extraction unit configured to extract a face contour from the face image captured by the image capturing unit; an ear position estimation unit configured to estimate positions of ears of the user on the basis of the extracted face contour; a distance estimation unit configured to estimate a distance between the communication apparatus and the user on the basis of the extracted face contour; a sound output unit configured to output sound having a directivity; and a control unit configured to control an output range of sound output from the sound output unit on the basis of the positions of ears of the user estimated by the ear position estimation unit and the distance between the communication apparatus and the user estimated by the distance estimation unit.

### CROSS-REFERENCE TO RELATED APPLICATIONS

This application is based upon and claims the benefit of priority of the prior Japanese Patent Application No. 2009-199855, filed on Aug. 31, 2009, the entire contents of which are incorporated herein by reference.

### FIELD

The present invention relates to a communication apparatus and a communication method.

### BACKGROUND

Mobile telephones having a video telephone function are becoming increasingly popular. In communication achieved by a video telephone function, the voice of a communication partner is output from a speaker since a user communicates with the communication partner while viewing the image of the communication partner. In current years, mobile telephones having a function of receiving a One-Seg broadcast are commercially available. When a user of this kind of mobile telephone communicates with a communication partner while watching a One-Seg broadcast, the voice of the communication partner may output from a speaker.

In communication performed with a speaker, not only a user but also surrounding people hear the voice of a communication partner. This is an annoyance to the surrounding people. A technique is known for optimally controlling the volume of an ear receiver or a speaker on the basis of the distance between a user and a telephone detected by a distance sensor and an ambient noise level detected by a noise detection microphone (see, for example, Japanese Unexamined Patent Application Publication No. 2004-221806.)

As a speaker having a directivity, an audible sound directivity controller having an array of a plurality of ultrasonic transducers and an ultrasonic transducer control unit for separately controlling these ultrasonic transducers so that ultrasound is output to a target position is known (see, for example, Japanese Unexamined Patent Application Publication No. 2008-113190.)

A technique for controlling the radiation characteristic of a sound wave output from an ultrasonic speaker in accordance with the angle of view of an image projected by a projector is known (see, for example, Japanese Unexamined Patent Application Publication No. 2006-25108.)

### SUMMARY

A communication apparatus includes an image capturing unit configured to capture a face image of a user; a contour extraction unit configured to extract a face contour from the face image captured by the image capturing unit; an ear position estimation unit configured to estimate positions of ears of the user on the basis of the extracted face contour; a distance estimation unit configured to estimate a distance between the communication apparatus and the user on the basis of the extracted face contour; an audio (also referred as “sound” hereinafter) output unit configured to output sound having a directivity; and a control unit configured to control an output range of sound output from the sound output unit on the basis of the positions of ears of the user estimated by the ear position estimation unit and the distance between the sound communication apparatus and the user estimated by the distance estimation unit.

The object and advantages of the invention will be realized and attained by at least the elements, features, and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating the configuration of a communication apparatus according to an embodiment of the present invention;

FIG. 2 is a flowchart illustrating a process performed by the communication apparatus;

FIG. 3 is a flowchart illustrating a face contour extraction process;

FIG. 4 is a flowchart illustrating a process of estimating an ear position and a user distance;

FIG. 5 is a diagram illustrating the relationship between the length of a captured image on a screen and the distance between a mobile telephone and a user;

FIG. 6 is a flowchart illustrating a modulation process;

FIG. 7 is a diagram illustrating the relationship among the distance between both ears, a user distance, and the directivity angle of a speaker; and

FIG. 8 is a diagram illustrating the relationship between the carrier frequency of a parametric speaker and a directivity angle.

### DESCRIPTION OF EMBODIMENTS

In various embodiments of the present invention, when audio or sound (for example, the voice of a communication partner) is output from a speaker in a communication apparatus, it is desired to substantially prevent surrounding people, other than the user of the communication apparatus, from hearing the sound. Furthermore, it is necessary to allow the user to hear the sound output from the speaker with certainty.

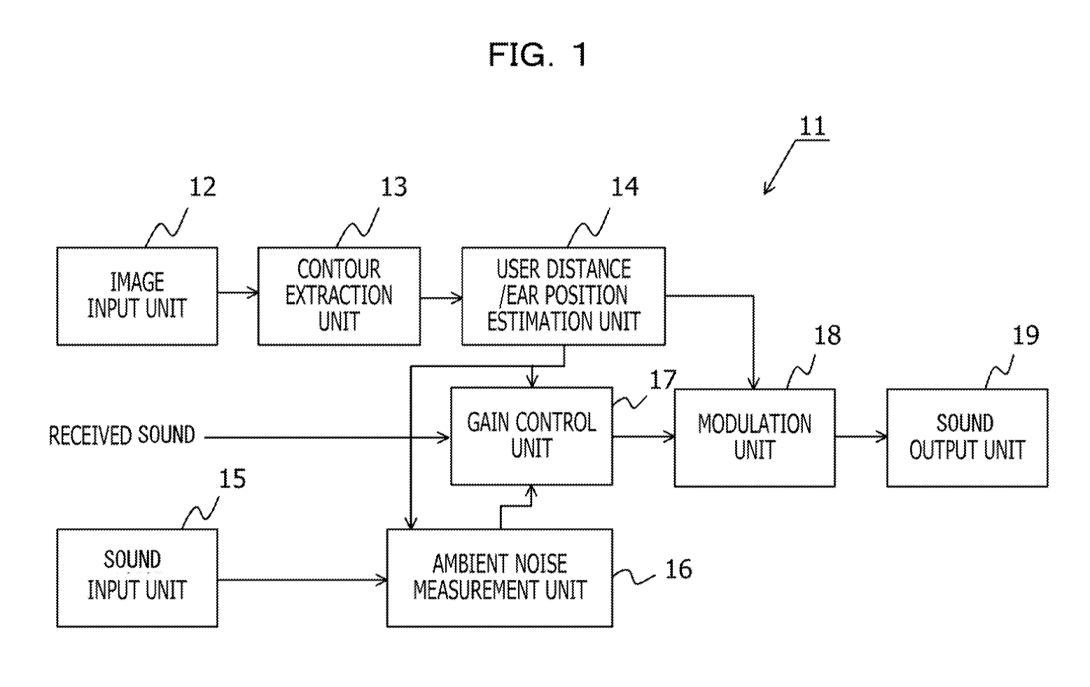

Embodiments of the present invention will be described below. FIG. 1 is a diagram illustrating the configuration of a main part of a communication apparatus 11 according to an embodiment of the present invention. The communication apparatus 11 is, for example, a mobile telephone or an apparatus used for a videoconference or an audio-video communication session.

An image input unit 12 is an image capturing unit such as a camera, and outputs a captured face image to a contour extraction unit 13. The contour extraction unit 13 extracts the contour of the face image and outputs the extracted contour to a user distance/ear position estimation unit 14.

The user distance/ear position estimation unit 14 estimates the distance to a user (hereinafter referred to as a user distance) and an ear position on the basis of the contour of a face of a user, the zooming factor of a camera, pieces of data each indicating the relationship between the size of a face contour and a distance to a user which are stored in advance in a storage apparatus. The pieces of data each indicating the relationship between the size of a face contour and a distance to a user are obtained by the same measurement apparatus and are stored in advance in a RAM or ROM along with zooming factor information.

For example, the ear position is obtained by representing a face contour in the form of ellipse and estimating each of the intersection points of a horizontal line passing through the center of the ellipse and a contour line as the ear position. Alternatively, an eye position is estimated on the basis of a face image, and each of the intersection points of a line connecting both eyes and a contour line is estimated as the ear position.

The user distance/ear position estimation unit 14 outputs the estimated distance to an ambient noise measurement unit 16 and a gain control unit 17 and outputs the estimated distance and the estimated ear position to a modulation unit 18. A sound input unit 15 is, for example, a microphone, and outputs ambient noise to the ambient noise measurement unit 16.

The ambient noise measurement unit 16 calculates an ambient sound level on the basis of a signal obtained when no sound signal is input. The ambient noise measurement unit 16 adds up the power of digital sound signals x(i) that are input from the sound input unit 15 at predetermined sampling intervals and calculates the power average of the digital sound signals x(i) as an ambient sound level pow. The ambient sound level pow is calculated with the following equation in which N represents the number of samples in a predetermined period.

pow=(1/N)Σx(i)²(i=0 to N−1)

The gain control unit 17 includes an amplification unit for amplifying sounds (e.g., the voice of a communication partner), and controls the gain of the amplification unit on the basis of an ambient sound level output from the ambient noise measurement unit 16. The gain control unit 17 increases the gain of the amplification unit when an ambient sound level is high, and reduces the gain of the amplification unit when an ambient sound level is low.

The gain control unit 17 calculates the gain of the amplification unit with a function gain having the ambient sound level pow and a user distance dist_u as variables. The function gain is represented by the following equation.

gain=f(pow,dist_{—}u)

The gain control unit 17 controls the gain of the amplification unit using this equation and outputs an amplified sound signal to the modulation unit 18.

On the basis of the estimated ear position output from the user distance/ear position estimation unit 14, the modulation unit 18 outputs from a sound output unit 19 a sound (e.g., a voice signal of the communication partner) having a directivity that directs the sound to the direction of ears of the user. The modulation unit 18 corresponds to, for example, a control unit for controlling the output range of sound that is externally output from the sound output unit 19.

The modulation unit 18 calculates an angle of each ear of the user with respect to the center axis of sound output of the sound output unit 19 on the basis of the estimated user distance and the estimated ear position that are transmitted from the user distance/ear position estimation unit 14, specifies a carrier frequency at which sound is output in the range of the angle, modulates a carrier wave of the specified carrier frequency with a sound signal, and outputs the modulated signal to the sound output unit 19.

The sound output unit 19 outputs the modulated signal output from the modulation unit 18. The sound output unit 19 is a speaker for outputting sound (e.g., voice) having a directivity. For example, a parametric speaker for outputting an ultrasonic wave may be used as the sound output unit 19. Since a parametric speaker uses an ultrasonic wave as a carrier wave, it is possible to obtain a sound output characteristic with a high directivity. For example, the modulation unit 18 variably controls the frequency of an ultrasonic wave on the basis of the estimated ear position and the estimated user distance that are transmitted from the user distance/ear position estimation unit 14, modulates an ultrasonic wave signal with a signal of received sound, and outputs a modulated signal to the sound output unit 19. When the sound output unit 19 outputs the modulated signal into the air, the signal of received sound used for modulation is subjected to self-demodulation. This occurs because of the nonlinearity of the air. As a result, the user hears the sound (e.g., voice of the communication partner). Since an ultrasonic wave signal output from the parametric speaker has a high directivity, sound output from the sound output unit is audible only at positions near the ears of the user.

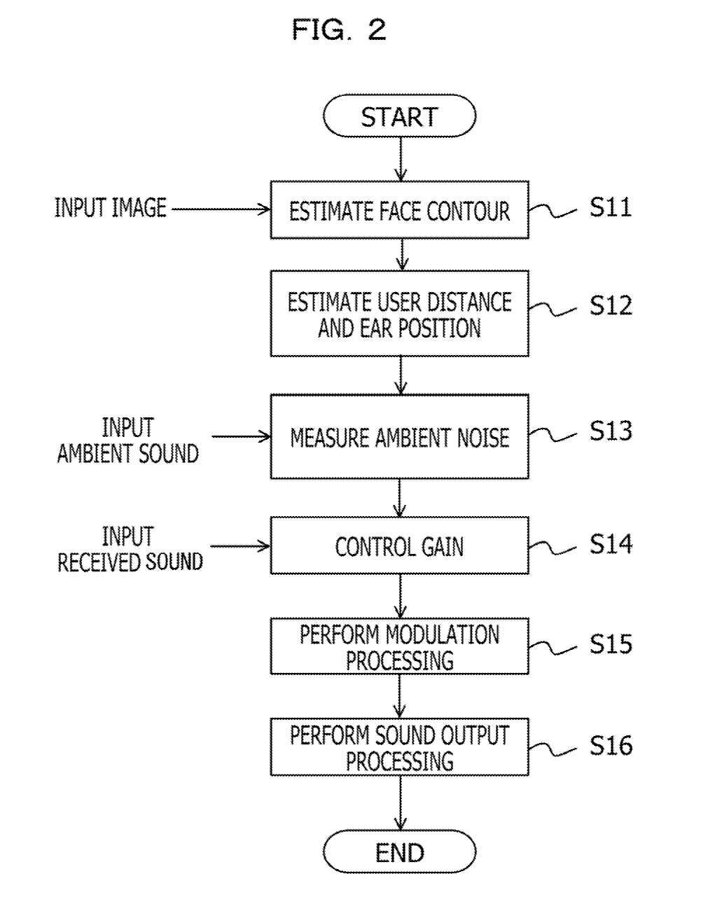

FIG. 2 is a flowchart illustrating a process performed by the communication apparatus 11. The following process is performed by, for example, a CPU in the communication apparatus 11. In step S11, the contour of a face image of a user captured by the image input unit 12 is estimated by the contour extraction unit 13. The contour extraction unit 13 may perform a contour extraction method as disclosed in, for example, Yokoyama Taro, et al., “Facial Contour Extraction Model,” Technical Report of IEICE, PRMU, 97 (387), pp. 47-53. There is another extraction method for setting an initial contour on the basis of the edge strength of each pixel in a face image, determining whether the difference between the edge strength (or an evaluated value obtained from the edge strength) of each point on the initial contour and an edge strength (or an evaluated value obtained from the edge strength) measured in the last determination is equal to or smaller than a predetermined value, and determining whether the convergence of the contour occurs by determining whether a state in which the difference is equal to or smaller than the predetermined value is repeated a predetermined number of times.

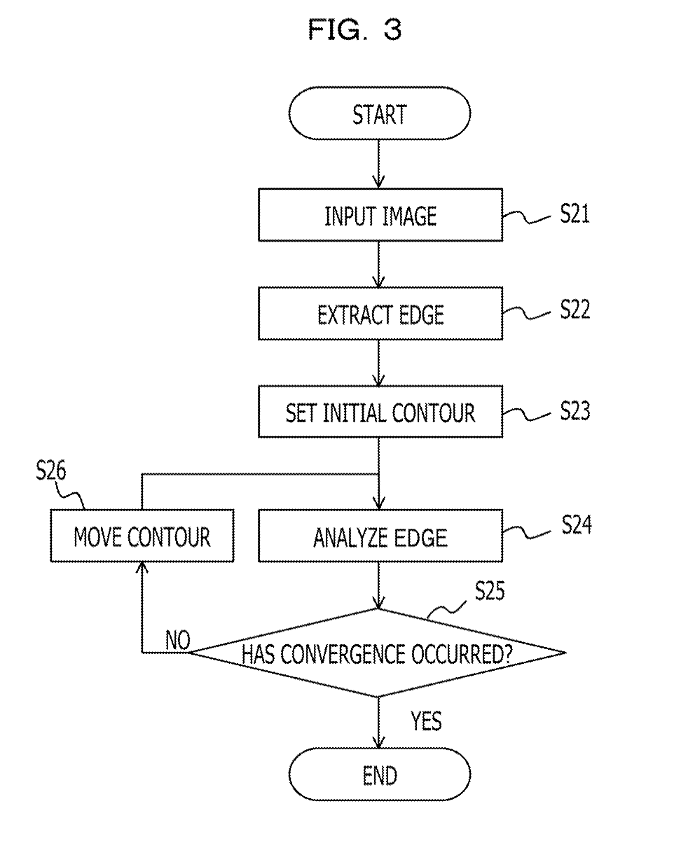

FIG. 3 is a flowchart illustrating details of the face contour extraction processing performed in step S11 in FIG. 2 by the contour extraction unit. When the face image of the user captured by the image input unit 12 is input in step S21, the edge of the face image is extracted in step S22. At that time, an edge extraction technique in the related art can be used.

On the basis of the extracted edge, an initial contour (closed curve) is set in step S23. After the initial contour has been set, the edge strength of each of a plurality of points on the initial contour is calculated and analyzed in step S24. It is determined whether convergence occurs on the basis of the edge strength of each of these points in step S25.

For example, it is determined whether convergence occurs by calculating the edge strength of each point on the contour, determining whether the difference between the edge strength and edge strength measured in the last determination is equal to or smaller than a predetermined value, and determining whether a state in which the difference is equal to or smaller than the predetermined value is repeated a predetermined number of times.

When it is determined that convergence does not occur (NO in step S25), the process proceeds to step S26 in which the contour is moved. Subsequently, the processing of step S24 and the processing of step S25 are performed. It is determined that convergence occurs (YES in step S25), the process ends.

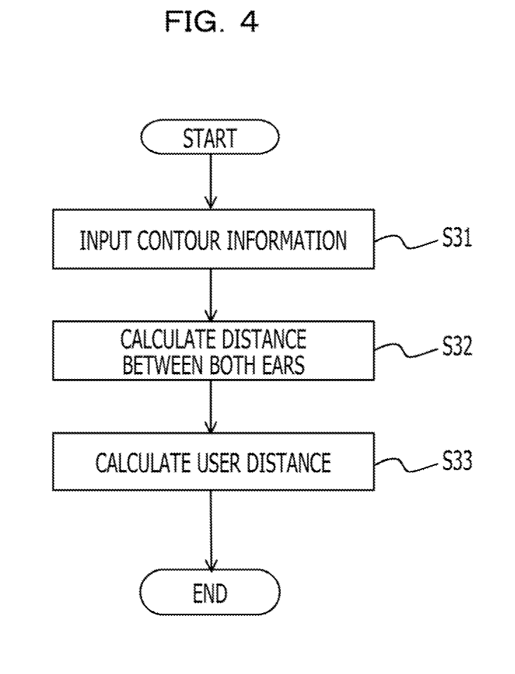

When the contour satisfies a predetermined convergence condition after the process from step S24 to step S26 has been repeated, the contour is estimated as a face contour. FIG. 4 is a flowchart illustrating details of the processing for estimating a user distance and an ear position performed in step S12 in FIG. 2 by the user distance/ear position estimation unit.

In step S31, face contour information obtained by the above-described face contour estimation processing is acquired. In step S32, the distance (dist_e) between both ears is calculated on the basis of the face contour information. For example, the center point of a face contour is calculated on the basis of the face contour information, and the distance between intersection points of a horizontal line passing through the center point and the face contour is calculated as the distance between both ears. Alternatively, the positions of eyes are estimated from a captured image, and the distance between intersection points of a line connecting both eyes and the face contour is calculated as the distance between both ears.

In step S33, the distance between a mobile telephone and a user is calculated on the basis of the distance between both ears, for example, as estimated from the captured image, and data of a face normal size obtained in advance. Experimentally obtained data shows that the width of a human frontal face (in the horizontal direction) is in the range of 153 mm to 163 mm irrespective of height and gender. Accordingly, it can be considered that the distance between both ears is approximately 160 mm.

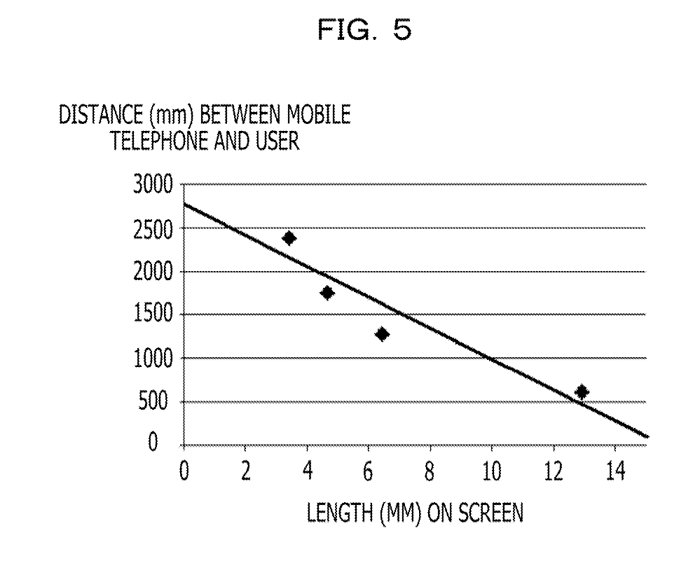

FIG. 5 is a diagram illustrating the relationship between the length of a captured image on a screen and the distance between a mobile telephone and a user of the mobile telephone. In FIG. 5, the length (mm) of the image of a face having the width of 160 mm displayed on the screen of a mobile telephone is determined each time the distance between the mobile telephone and the user is changed, and results of the determination are plotted. In FIG. 5, a horizontal axis represents the width of a face of a user of a mobile telephone on a captured image, and a vertical axis represents the distance between the mobile telephone and the user.

In the case of an example illustrated in FIG. 5, the distance between the mobile telephone and the user is approximately 500 mm when the width of the face of the user on a captured image displayed on the screen of the mobile telephone is 13 mm. The distance between the mobile telephone and the user is approximately 1500 mm when the width of the face of the user on a captured image displayed on the screen of the mobile telephone is 7 mm.

According to the plotted results shown in FIG. 5, an equation to be used to determine the distance (dist_u (mm)) between a mobile telephone and a user from the width of a face on a captured image with a least squares method is as follows.

dist_{—}u=−177.4× the distance (mm) between both ears on a screen+2768.2

The above-described equation is used to calculate the distance between a mobile telephone and a user from the width of a face on an image captured by the mobile telephone. However, an equation used to calculate the distance between a mobile telephone and a user is not limited to the above-described equation, and may be obtained in accordance with the performance or zooming factor of a camera of a mobile telephone.

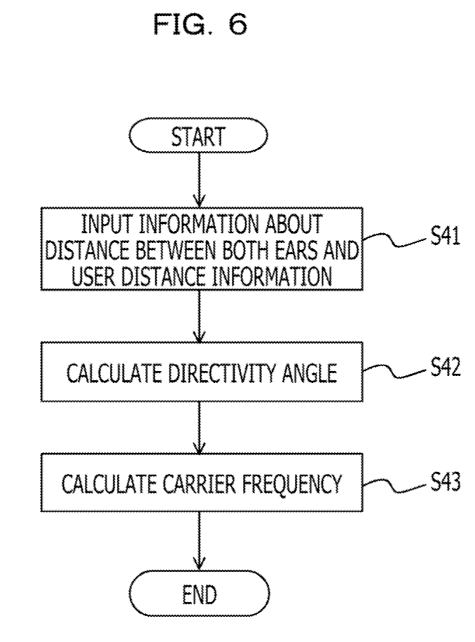

FIG. 6 is a flowchart illustrating details of modulation processing performed in step S15 in FIG. 2. In step S41, the distance between both ears calculated in step S32 in FIG. 4 and the user distance information calculated in step S33 in FIG. 4 are input.

In step S42, a directivity angle (radiation angle) 9 of sound output from a speaker is calculated. In order to transmit sound to the positions of ears of a user and to substantially prevent the sound from being heard at other positions, the directivity angle of a speaker having a directivity may be controlled. In step S43, a carrier frequency is calculated on the basis of the calculated directivity angle θ and data indicating the relationship between a directivity angle and a carrier frequency which has been obtained in advance.

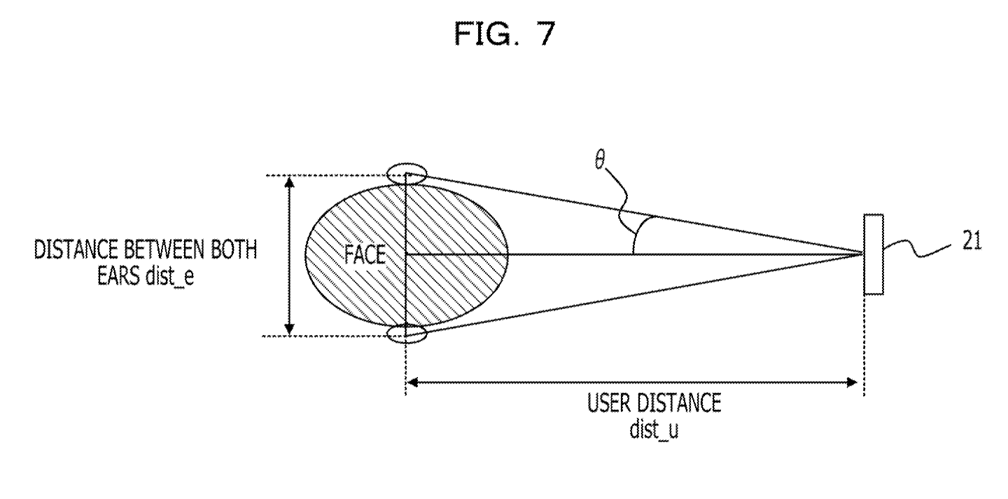

FIG. 7 is a diagram illustrating the relationship among the distance between both ears, a user distance, and the directivity angle θ of a speaker of a mobile telephone 21. The directivity angle θ of the speaker can be represented by the following equation in which dist_e represents the distance between both ears and dist_u represents the distance between the mobile telephone 21 and a user.

θ=arctan {dist_{—}e/(2·dist_{—}u)}

When the distance dist_e between both ears and the user distance dist_u are acquired in step S41, the control angle of a speaker, that is, the directivity angle θ, is calculated using the above-described equation in step S42. The directivity angle θ is an angle of one of the ears of a user with respect to the center (i.e., output) axis of a speaker. In this case, the sum of angles of ears of a user with respect to the center axis of a speaker is 2θ.

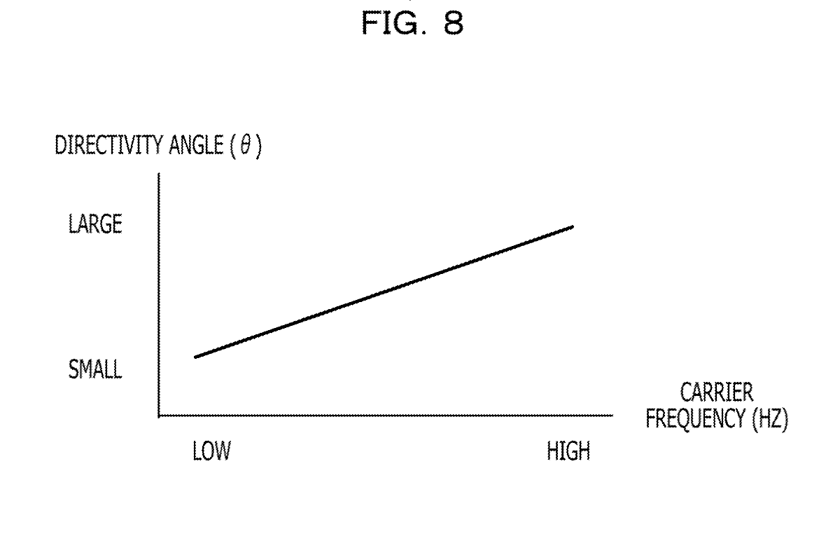

FIG. 8 is a diagram illustrating the relationship between the carrier frequency of a parametric speaker and a directivity angle. As illustrated in FIG. 8, the directivity angle of a parametric speaker increases with the increase in a carrier frequency, and decreases with the decrease in a carrier frequency.

Accordingly, when the directivity angle θ of a speaker is obtained, a carrier frequency at which a desired directivity angle θ is obtained can be calculated on the basis of data indicating the relationship between the directivity angle θ and a carrier frequency which is represented by a graph illustrated in FIG. 8. The graph illustrated in FIG. 8 indicates a carrier frequency corresponding to an angle θ of one of the ears of a user with respect to the center axis of a speaker. By selecting a carrier frequency at which a desired directivity angle θ, that is, the directivity angle θ at sound voice is transmitted to the positions of both ears of a user, is obtained, it is possible to transmit sound to the positions of both ears of the user.

In an embodiment of the present invention, the image of a face of a user of the communication apparatus 11 is captured. On the basis of a contour of the captured face image, the positions of ears of the user are estimated. On the basis of the distance between both ears of the user, the distance between the communication apparatus 11 and the user is estimated. On the basis of the distance between both ears of the user and the distance between the communication apparatus 11 and the user, the frequency of a carrier wave output from a speaker or the like is controlled. As a result, it is possible to transmit sound (e.g., voice of a communication partner) to only positions near the positions of ears of the user. Accordingly, it is possible to substantially prevent sound output from a speaker or the like from being heard by people around the user. Since it is unnecessary to adjust the position and output direction of the communication apparatus 11 so as to substantially prevent sound output from a speaker from being heard from surrounding people, the convenience of a user is increased.

By controlling a gain in accordance with ambient noise, sound can be output from a speaker at an appropriate volume in accordance with ambient noise of a user. In an embodiment of the present invention, a mobile telephone including a camera and a speaker has been described. However, the camera and the speaker may not be necessarily included in the same apparatus. For example, when a communication apparatus is used at a videoconference, a camera and a speaker may be separately disposed and the output range of the speaker may be controlled on the basis of a face image captured by the camera so that sound output from the speaker is transmitted to the positions of ears of a user.

The systems and methods recited herein may be implemented by a suitable combination of hardware, software, and/or firmware. The software may include, for example, a computer program tangibly embodied in an information carrier (e.g., in a machine readable storage device) for execution by, or to control the operation of, a data processing apparatus (e.g., a programmable processor). A computer program can be written in any form of programming language, including compiled or interpreted languages, and it can be deployed in any form, including as a stand-alone program or as a module, component, subroutine, or other unit suitable for use in a computing environment.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Although the embodiments of the present inventions has been described in detail, it should be understood that the various changes, substitutions, and alterations could be made hereto without departing from the spirit and scope of the invention.

What is claimed is:

1. A communication apparatus comprising:
an image capturing unit configured to capture a face image of a user;
a contour extraction unit configured to extract a face contour from the face image captured by the image capturing unit;
an ear position estimation unit configured to estimate positions of ears of the user on the basis of the extracted face contour;
a distance estimation unit configured to estimate a distance between the communication apparatus and the user on the basis of the extracted face contour;
a sound output unit configured to output sound having a directivity; and
a control unit configured to control an output range of sound output from the sound output unit on the basis of the positions of ears of the user estimated by the ear position estimation unit and the distance between the communication apparatus and the user estimated by the distance estimation unit.

2. The communication apparatus according to claim 1, wherein the control unit calculates an angle of an ear of the user with respect to a center axis of an output of the sound output unit on the basis of the positions of ears of the user and the distance between the communication apparatus and the user, and controls the output range of sound output from the sound output unit on the basis of the calculated angle.

3. The voice communication apparatus according to claim 1, wherein the control unit calculates an angle of an ear of the user with respect to a center axis of an output of the sound output unit on the basis of the positions of ears of the user and the distance between the communication apparatus and the user, and controls a frequency of a carrier wave of sound output from the sound output unit on the basis of the calculated angle.

4. The communication apparatus according to claim 2,
wherein the sound output unit is a parametric speaker, and
wherein the control unit controls a frequency of an ultrasonic wave output from the parametric speaker on the basis of the calculated angle.

5. The communication apparatus according to claim 1 further comprising a sound measurement unit configured to measure a sound level around the user, and
wherein the control unit includes amplifying means for amplifying a sound signal to be output by the sound output unit, and controls a gain of the amplifying means in accordance with the sound level measured by the sound measurement unit.

6. A communication method comprising:
capturing a face image of a user;
extracting a face contour from the captured face image;
estimating positions of ears of the user on the basis of the extracted face contour;
estimating a distance to the user on the basis of the extracted face contour; and
controlling an output range of sound output from a sound outputting unit having a directivity on the basis of the estimated positions of ears of the user and the estimated distance to the user.

7. The communication method according to claim 6, further comprising:
calculating an angle of an ear of the user with respect to a center axis of an output of the sound outputting unit on the basis of the estimated positions of ears of the user and the estimated distance to the user; and
controlling the output range of sound output from the sound outputting unit on the basis of the calculated angle.

8. Information processing apparatus comprising:
an image capturing unit configured to capture a face image of a user;
a contour extraction unit configured to extract a face contour from the face image captured by the image capturing unit;
an ear position estimation unit configured to estimate positions of ears of the user on the basis of the extracted face contour;
a distance estimation unit configured to estimate a distance between the information processing apparatus and the user on the basis of the extracted face contour;
a sound output unit configured to output sound having a directivity; and
a control unit configured to control an output range of sound output from the sound output unit on the basis of the positions of ears of the user estimated by the ear position estimation unit and the distance between the information processing apparatus and the user estimated by the distance estimation unit.
